(19) United States
(12) Patent Application Publication
(10) Pub. No.: US 2014/0035309 A1
(43) Pub. Date: Feb. 6, 2014

(54) VEHICLE BODY EXPANSION FOAM

(71) Applicants: Mingher Fred Shen, Ann Arbor, MI (US); Scott W. Shopoff, Ann Arbor, MI (US)

(72) Inventors: Mingher Fred Shen, Ann Arbor, MI (US); Scott W. Shopoff, Ann Arbor, MI (US)

(73) Assignee: Toyota Motor Engineering & Manufacturing North America, Inc., Erlanger, KY (US)

(21) Appl. No.: 13/565,237

(22) Filed: Aug. 2, 2012

(51) Int. Cl. B60R 13/08; E04B 1/682

(52) U.S. Cl. 296/39.3; 277/316

(57) ABSTRACT

A method and apparatus for blocking the passage of air through a connection portion of two vehicle body portions. A first vehicle body portion is provided having a generally planar first surface. Expandable foam is mounted to the first surface of the first vehicle body portion. A second vehicle body portion having a generally planar second surface is connected to and overlapping the first surface of the first vehicle body portion thereby fully covering the expandable foam. The expandable foam expands when heated and is operable to expand to fill gaps to prevent the passage of air thereby preventing turbulent mixing of the air flow flowing between the first and second vehicle body portions with the air flow flowing from outside the vehicle. A method is further provided for blocking the passage of air through the connection portion of two vehicle body portions.

### FIELD OF THE INVENTION

The present invention relates generally to vehicle body panels. More particularly, this invention relates to the prevention of air flow through the connection of two or more vehicle body panels.

### BACKGROUND OF THE INVENTION

A frequent customer complaint which engineers strive to minimize is the noise heard by the user in the cabin of the vehicle during vehicle operation. These noises, commonly wind noises, are often created at the seam or connection of a plurality of body panels of a vehicle. A common area creating a high turbulence and therefore a high noise is the area where the fender and the side member of a vehicle meet. These two body members are traditionally bolted together and create a seam at either side of the vehicle windshield.

As the vehicle is in motion, air flows through the engine cavity and out through the seam created between the fender and the side member. Furthermore, air flows over the hood of the vehicle to the area where the seam connecting the fender and the side member is located. Air flowing from these various locations mixes and creates a high turbulence area (see reference numeral 46 at FIG. 2). This turbulence is heard by occupants inside the vehicle. Therefore, there exists a need in the art to eliminate the air flow between the fender and the side member reduces mixing of air streams outside the vehicle to minimize the noise heard inside the vehicle. Accordingly, there exists a need in the art to provide a connection means between two vehicle body portions to prevent the flow of air thereby preventing unwanted noise heard by the occupant of a vehicle.

### SUMMARY OF THE INVENTION

The present invention relates to a method and apparatus for blocking the passage of air through a connection portion of two vehicle body portions. A first vehicle body portion is provided having a generally planar first surface. Expandable foam is mounted to the first surface of the first vehicle body portion. A second vehicle body portion having a generally planar second surface is connected to and overlapping the first surface of the first vehicle body portion thereby fully covering the expandable foam. The expandable foam expands when heated to a temperature of between 200 and 450 degrees Fahrenheit and is operable to expand to fill gaps. After baking, the foam forms a barrier between the first vehicle body portion and the second vehicle body portion which prevents the passage of air through the seam thereby preventing turbulence and noise heard by the occupant of a vehicle.

A method is further provided for blocking the passage of air through the connection portion of two vehicle body portions. The method includes the steps of placing an expandable foam on a first vehicle body portion, overlapping the second vehicle body portion over the expandable foam, securing the second vehicle body portion to the first vehicle body portion, and heating the first vehicle body portion, the second vehicle body portion, and the expandable foam allowing the expandable foam to expand and fill gaps to block the passage of air between the first vehicle body portion and the second vehicle body portion thereby reducing the noise heard by the occupant of the vehicle.

### BRIEF DESCRIPTION OF THE DRAWINGS

FIG. 1 illustrates a perspective view of a vehicle having a plurality of body portions;

FIG. 2 is an exploded side view (as shown in FIG. 1) of the turbulence created by the air flow;

FIG. 3 is a perspective view of the expandable foam of the present invention;

FIG. 4 illustrates an exploded perspective view of the body portions and the expandable foam;

FIG. 5 illustrates an exploded perspective view of the body portions and the expandable foam;

FIG. 6 illustrates a cross-sectional view along the line 6-6 as shown in FIG. 4 of the assembly having the expandable foam pre-expansion; and FIG. 7 illustrates a cross-sectional view of the assembly along the line 7-7 as shown in FIG. 4 of the expanded foam in an expanded and filled state.

### DETAILED DESCRIPTION OF THE INVENTION

The present invention relates to a method and apparatus for preventing the flow of air through two body portions or panels. An expandable foam is mounted to one of these panels and the panels are thereafter secured to one another. During the baking process of the vehicle body, the expandable foam expands to fill gaps between the two portions to block air flow between the portions. The expandable foam blocks the air flow and thereby prevents turbulent mixing of the air flow flowing between the vehicle body portions and the air flow flowing over the vehicle hood. This turbulence is created near the windshield of the vehicle and subsequently the decrease in turbulence reduces the noise heard by the vehicle occupant.

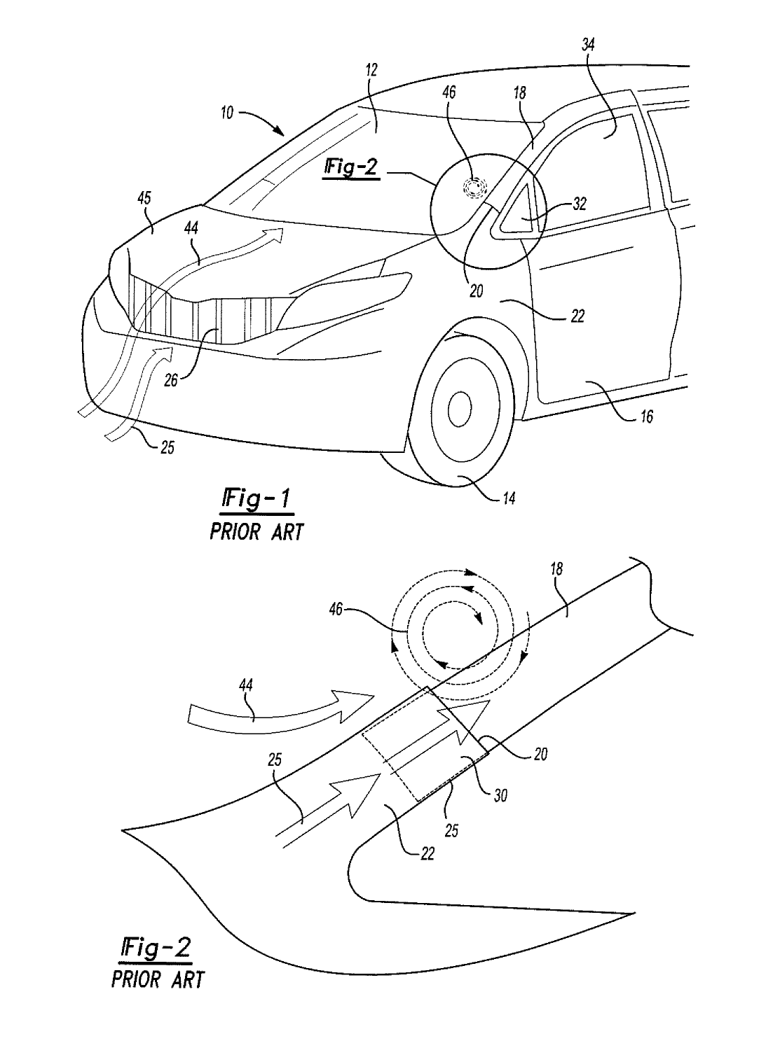

FIG. 1 illustrates a perspective view of the vehicle 10 of the present invention. The vehicle 10 includes a windshield 12 and a set of wheels 14. The vehicle 10 further includes a driver door 16 having a window 34. A side window 32 is also provided. A fender 22 is connected to the side member 18 of the vehicle 10. A seam 20 is created between the fender 22 and the side member 18.

The vehicle 10 further includes a grille 26 operable to accept the flow of air 25 into the vehicle engine cavity. Air 25 flows through the engine cavity and out the seam 20. Furthermore, the vehicle 10 includes a vehicle hood 45. Air created when the vehicle 10 is in motion passes over the hood 45, as illustrated by reference numeral 44. The air 25 flowing out the seam 20 and the air 44 flowing over the vehicle hood and over the vehicle windshield 12 creates turbulence 46 and significant noise to the vehicle occupant. The seam 20 is created by an overlap 30 of the side member 18 and the fender 22.

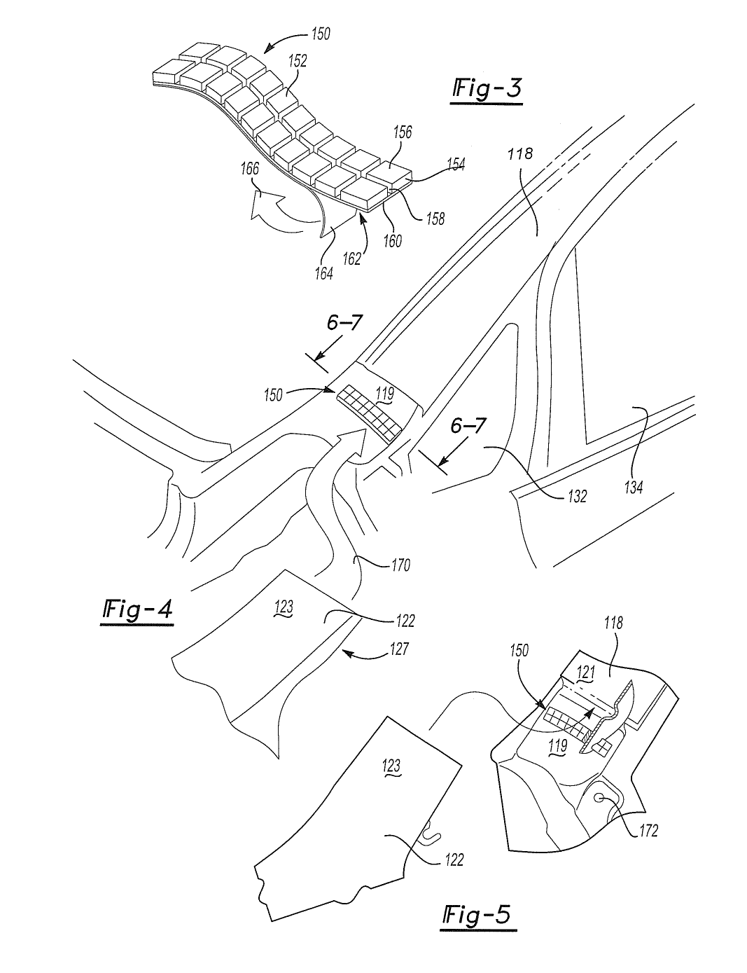

FIG. 3 illustrates the expandable foam 150 as used in the present invention. The expandable foam 150 is generally an elongated strip having a plurality of square shaped portions of expandable foam. The expandable foam 150 is generally rectangular shaped. The expandable foam 150 is resilient and pliable to form on a curved surface. A plurality of generally square protrusions 152 cover the upper surface of the expandable foam 150. The protrusions 152 include an upper surface 156 and side walls 154. The protrusions 152 rest on a base portion 160 of the expandable foam 150. The base portion 160 may be comprised of the same material as the expandable foam protrusions 152, or it may be a stability enhancing base material. The protrusions 152 create a plurality of grooves 158 along the upper surface of the expandable foam 150. Expandable foam 150 further includes a lower surface 162 having a glue or other adhesive means to attach the expandable foam 150 to a surface. In the present embodiment, the expandable foam 150 includes double sided tape adhered to the lower surface 162. The adhesive is exposed by removal of the sheet 164, as shown by reference numeral 166. This adhesive may be in the form of a sticker, double sided tape, glue, tape or other suitable mounting means.

The expandable foam 150 is placed between two body portions 118 and 122. The side member 118 includes a an exterior surface, or first surface 119. The first surface 119 is generally planar and operable to accept the double sided tape of the expandable foam 150. The exterior surface, or first surface 119, is a surface on an exterior body panel (side member 118) of a vehicle component. This surface is traditionally covered with a coating, or paint. The expandable foam 150 rests on and is mounted to the first surface 119 of the side member 118. The fender 122 is positioned and mounted 170 over the expandable foam 150. The fender 122 includes an exterior surface, or upper surface 123, and a lower surface 127. The exterior surface, or upper surface 123, is a surface on an exterior body panel (fender 122). This surface is traditionally coated with covered with a coating, or paint. When the fender 122 is mounted securely to the side member 118, the lower surface 127 of the fender 122 comes into close contact with, or comes close to contact with the expandable foam 150 and the first surface 119 of the side member 118. The fender 122 is mounted to the side member 118 by means of a plurality of connection portions 172, 174. The expandable foam 150 is used to seal, or block airflow between, or to prevent the escape of air out of the seam between two exterior vehicle body portions. In this embodiment, these portions are the fender 122 and the side member 118.

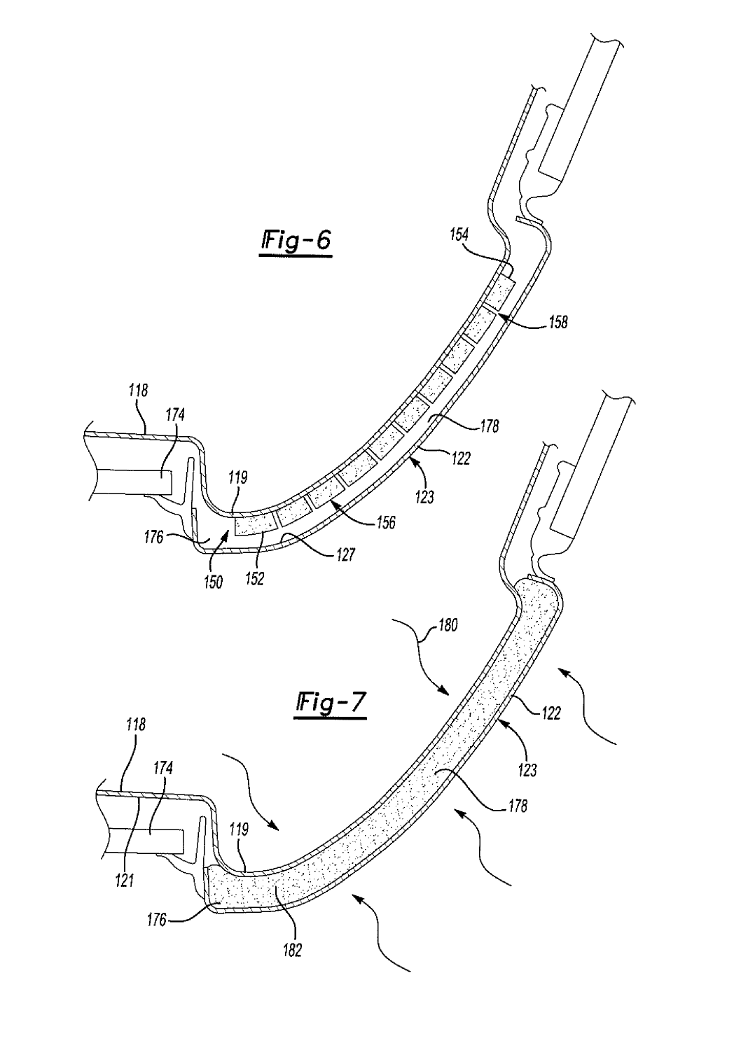

FIGS. 6 and 7 are cross-sectional views along the lines 6-6 and 7-7 as shown in FIG. 4. The side member 118 is shown with the first surface 119 and the expandable foam 150 mounted thereto. The fender 122 is shown having the outer surface 123 and the inner surface 127. The fender 122 is mounted and attached to the side member 118 by means of connection member 174. The connection member 174, in the present embodiment, is a clip. The connection member may also be a bolt attachment, or other suitable connection means. Open space 176, 178 is created between the side member 118 and the fender 122, and between the expandable foam 150. As the assembly undergoes a heat treatment process 180, the expandable foam 150 expands to an expanded state 182, as shown in FIG. 7. The vehicle body undergoes a heat treatment process of between 200 and 450 degrees Fahrenheit wherein the expandable foam 150 expands and fills the open spaces 176, 178 to an expanded state 182. This heat treatment process is traditionally used for various other expandable foam applications, paint treatments, coat treatments, sealants, and the like.

A method of blocking the passage of air through the connection portion of two vehicle body portions, the method comprising the steps of, placing expandable foam on a first vehicle body portion, overlapping the second vehicle body portion over the expandable foam, securing the second vehicle body portion to the first vehicle body portion, and heating the first vehicle body portion, the second vehicle body portion and the expandable foam allowing the expandable foam to expand and block the passage of air between the first vehicle body portion and the second vehicle body portion. In the present embodiment, the expandable foam is a sticker. The method further includes the step of removing a sticker back before application to the first body portion. The first vehicle body portion, the second vehicle body portion and the expandable foam is heated to a temperature between 200-450 degrees Fahrenheit. After this baking process, the foam expands to fill any gaps to prevent the flow of air. The blocked air prevents/minimizes the turbulent mixing of the air flow flowing between the first and second vehicle body portions and the air flowing outside the vehicle. Without this blocking, noise can be heard by the customer within the vehicle cabin. Air is prevented from flowing, and thus noise is prevented.

The baking as discussed above is carried out simultaneously with the baking process already being carried out. The baking process is traditionally implemented to bake on paint, coatings or set and secure other materials. The process of baking the expandable foam does not require it's own baking process. The expandable foam of the present invention is expanded during the standard process already in place. This minimizes cost and energy required in manufacturing. The heating of the first body portion (side member), the second body portion (fender) and the expandable foam occurs during a standard baking process already used to cure vehicle body coatings.

This invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. A method of blocking the passage of air through the connection portion of two vehicle body portions, the method comprising the steps of:
mounting a strip of expandable foam having a first surface on an arcuate first surface of an elongated first vehicle body portion, mounting the first surface of the expandable foam to the first surface of the first vehicle body portion, the first surface positioned at a first end of the first vehicle body portion;
overlapping an arcuate second surface of an elongated second vehicle body portion over the expandable foam, the second surface positioned at a second end of the second vehicle body portion, the first elongated body portion and the second elongated body portion extending away from one another and extending away from the strip of expandable foam, the expandable foam positioned adjacent to a vehicle windshield;
securing the second vehicle body portion to the first vehicle body portion; and
heating the first vehicle body portion, the second vehicle body portion and the expandable foam allowing the expandable foam to expand and block the passage of air between the first vehicle body portion and the second vehicle body portion.

2. The method of claim 1 wherein the expandable foam includes an adhesive.

3. The method of claim 2 wherein the method further includes the step of removing a cover over the adhesive before application to the first body portion.

4. The method of claim 1 wherein the first vehicle body portion, the second vehicle body portion and the expandable foam is heated to a temperature between 200-450 degrees Fahrenheit to expand the foam and block the transmission of air between the first vehicle body portion and the second vehicle body portion.

5. The method of claim 1 wherein the heating of the first body portion, the second body portion and the expandable foam occurs during a standard baking process already used to cure vehicle body coatings.

6. The method of claim 1 wherein the first vehicle body portion and the second vehicle body portion are exterior vehicle body portions.

7. A vehicle body assembly for preventing the flow of air at a specific vehicle body area, the assembly comprising:
a first elongated vehicle body portion having a first surface, the first vehicle body portion having a first end, the first surface positioned at the first end;
an expandable foam having a first surface, the first surface of the expandable foam mounted to the first surface of the first vehicle body portion; and
a second elongated vehicle body portion having a second surface, the second vehicle body portion having a second end, the second surface positioned at the second end, the second surface and second end overlapping the first surface and free end of the first vehicle body portion and fully covering the expandable foam, the first elongated body portion and the second elongated body portion extending away from one another only connected at the first end and the second end, the expandable foam positioned adjacent to a vehicle windshield, the expandable foam operable to expand when exposed to heat to block the flow of air from the engine compartment.

8. The assembly of claim 7 wherein the first vehicle body portion is an exterior vehicle body portion.

9. The assembly of claim 7 wherein the second vehicle body portion is an exterior vehicle body portion.

10. The assembly of claim 7 wherein the first vehicle body portion is a side member.

11. The assembly of claim 7 wherein the second vehicle body portion is a fender.

12-13. (canceled)

14. The assembly of claim 7 wherein the expandable foam expands when heated to a temperature of between 200-450 degrees Fahrenheit and is operable to expand to fill gaps to prevent the passage of air.

15. The assembly of claim 7 wherein the expandable foam includes a second surface.

16. The assembly of claim 15 wherein the second surface of the expandable foam includes segmented second surface.
